(19) United States
(12) Patent Application Publication
(10) Pub. No.: US 2024/0348905 A1
(43) Pub. Date: Oct. 17, 2024

(54) CAMERA MODULE

(71) Applicant: Japan Display Inc., Tokyo (JP)

(72) Inventors: Kasumi HASE, Tokyo (JP); Koichi IGETA, Tokyo (JP); Kentaro OKUYAMA, Tokyo (JP)

(73) Assignee: Japan Display Inc., Tokyo (JP)

(21) Appl. No.: 18/749,860

(22) Filed: Jun. 21, 2024

Related U.S. Application Data
(63) Continuation of application No. PCT/JP2022/045259, filed on Dec. 8, 2022.

(30) Foreign Application Priority Data
Dec. 21, 2021 (JP) 2021-207123

(51) Int. Cl. H04N 23/55; G02F 1/1343; G02F 1/1347

(52) U.S. Cl. CPC H04N 23/55; G02F 1/134309; G02F 1/13476

(57) ABSTRACT

According to one embodiment, a camera module includes a liquid crystal panel which displays a coded-aperture pattern, an image sensor, and an optical system located between the liquid crystal panel and the image sensor. The liquid crystal panel includes a liquid crystal layer containing liquid crystal molecules and polymers.

### CROSS-REFERENCE TO RELATED APPLICATIONS

This application is a Continuation Application of PCT Application No. PCT/JP2022/045259, filed Dec. 8, 2022 and based upon and claiming the benefit of priority from Japanese Patent Application No. 2021-207123, filed Dec. 21, 2021, the entire contents of all of which are incorporated herein by reference.

### FIELD

Embodiments described herein relate generally to a camera module.

### BACKGROUND

A camera module including a liquid crystal panel, an image sensor located on the back of the liquid crystal panel, and an optical system located between the liquid crystal panel and the image sensor has recently been developed.

In the camera module, a coded-aperture technology for using a blur caused in an image generated based on light incident upon the image sensor to calculate a distance from the camera module to a subject in the image is known

However, the camera module functions as a normal camera except for the calculation of the distance to the subject described above. It is thus desirable that the transmittance of the liquid crystal panel be high from the viewpoint of the amount of light that can be made incident upon the image sensor.

### BRIEF DESCRIPTION OF THE DRAWINGS

FIG. 1 is an exploded perspective view showing an example of a configuration of a camera module according to an embodiment.

FIG. 2 is a plan view showing a pattern example of an incident light control area formed on a liquid crystal panel.

FIG. 3 is a plan view showing another pattern example of the incident light control area formed on the liquid crystal panel.

FIG. 4 is an illustration of the principle of calculating a distance to a subject using the camera module.

FIG. 5 is a schematic sectional view of the liquid crystal panel.

FIG. 6 is a sectional view illustrating a configuration example of a liquid crystal layer.

FIG. 7 is a schematic diagram showing an OFF-state liquid crystal layer and an ON-state liquid crystal layer.

FIG. 8 is a schematic diagram showing an OFF-state liquid crystal layer and an ON-state liquid crystal layer according to a first modification.

FIG. 9 is a schematic diagram showing an OFF-state liquid crystal layer and an ON-state liquid crystal layer according to a second modification.

### DETAILED DESCRIPTION

In general, according to one embodiment, a camera module comprises a liquid crystal panel which displays a coded-aperture pattern, an image sensor, and an optical system located between the liquid crystal panel and the image sensor. The liquid crystal panel includes a liquid crystal layer containing liquid crystal molecules and polymers.

Embodiments will be described hereinafter with reference to the accompanying drawings.

Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

Further, note that, in order to make the descriptions more easily understandable, some of the drawings illustrate an X axis, a Y axis and a Z axis orthogonal to each other. A direction along the X axis is referred to as an X direction or a first direction X, a direction along the Y axis is referred to as a Y direction or a second direction Y and a direction along the Z axis is referred to as a Z direction or a third direction Z.

The present specification describes a camera module capable of using an image of a subject picked up by a camera to calculate a distance from the camera to the subject in the image (referred to simply as a distance to the subject hereinafter).

As a technology for calculating a distance to the subject, for example, a coded-aperture technology can be used. Though not described in detail, the coded-aperture technology is one for analyzing a blur caused in an image in accordance with the position of a subject to calculate a distance to the subject.

That is, the use of the above coded-aperture technology makes it possible to calculate a distance to a subject based on its image and create a depth map representing the distance to the subject. Note that a process of calculating a distance to a subject, a process of creating a depth map, and the like are performed by a controller (CPU) that controls the operation of a camera module or a controller of an electronic device (electronic device equipped with a camera module) connected to the camera module.

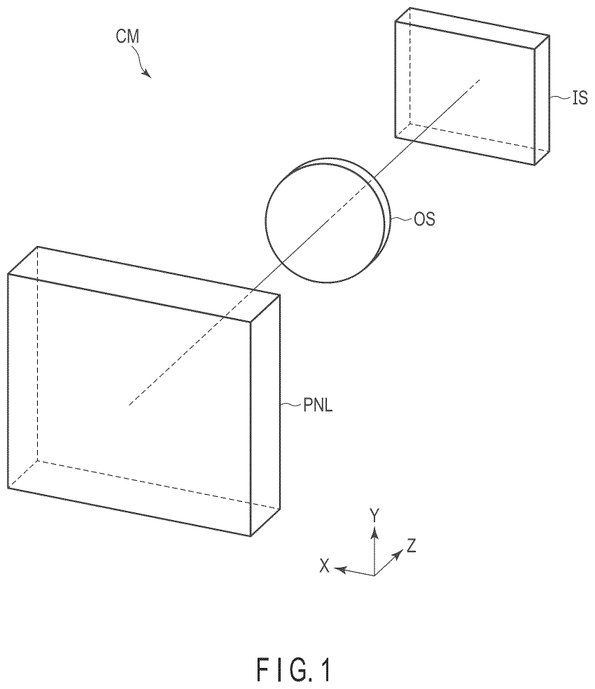

FIG. 1 is an exploded perspective view showing an example of a configuration of a camera module CM according to an embodiment. As shown in FIG. 1, the camera module CM includes a liquid crystal panel PNL, an image sensor (imaging device) IS located alongside the back of the liquid crystal panel PNL, and an optical system OS located between the liquid crystal panel PNL and the image sensor IS. That is, in the camera module CM, the liquid crystal panel PNL, optical system OS and image sensor IS are arranged in this order along a third direction Z. The optical system OS includes at least one lens, and the optical system OS and image sensor IS constitute a camera that picks up an image.

The liquid crystal panel PNL includes a first substrate (array substrate), a second substrate (counter substrate), and a liquid crystal layer located between the first and second substrates, which will be described in detail. The liquid crystal layer is polymer dispersed liquid crystal. The liquid crystal panel PNL is adapted to a reverse mode in which it is brought into a transparent state if no electric field is applied to the liquid crystal layer and it is brought into a scattered state if an electric field is applied to the liquid crystal layer. The transparent state is a state in which light incident upon the liquid crystal layer is transmitted almost without being scattered in the liquid crystal layer. The scattered state is a state in which light incident upon the liquid crystal layer is scattered in the liquid crystal layer. The reverse mode has the advantage of better responsiveness than the normal mode in which the liquid crystal panel PNL is brought into a scattered state if no electric field is applied to the liquid crystal layer and it is brought into a transparent state if an electric field is applied to the liquid crystal layer. Note that the liquid crystal panel PNL may be driven by a simple matrix system or an active matrix system. In the present embodiment, the liquid crystal panel PNL is driven by the active matrix system.

In the camera module CM according to the present embodiment, when the liquid crystal panel PNL is in a transparent state, light transmitted through the liquid crystal panel PNL and the optical system OS enters the image sensor IS. Thus, the camera module CM can pick up an image based on the light that has entered the image sensor IS.

On the other hand, when the liquid crystal panel PNL is in a scattered state, a coded-aperture pattern is displayed on the liquid crystal panel PNL to form a large number of incident light control areas. That is, light, which is transmitted through the liquid crystal panel PNL and the optical system OS in which the coded-aperture pattern is displayed, is incident upon the image sensor IS. Thus, the camera module CM can calculate a distance to a subject from an image based on the light incident upon the image sensor IS by the coded-aperture technology described above.

Note that FIG. 1 illustrates the positional relationship among the liquid crystal panel PNL, optical system OS and image sensor IS in the third direction Z. In FIG. 1, the size, shape and the like of the liquid crystal panel PNL, optical system OS and image sensor IS are simply shown.

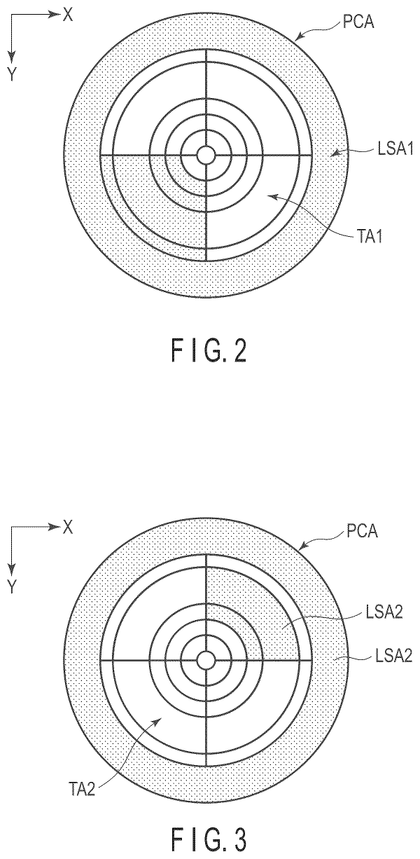

FIGS. 2 and 3 are plan views each showing a pattern example of an incident light control area PCA formed on the liquid crystal panel PNL. The incident light control area PCA includes a light-shielding area LSA that shields light incident upon the image sensor IS and a light-transmitting area TA that transmits light incident upon the image sensor IS. The incident light control area PCA is shaped like a circle, for example, and the light-shielding area LSA includes at least an annular portion located at the outermost periphery of the incident light control area PCA. In FIGS. 2 and 3, the dotted areas corresponds to the light-shielding area LSA and the other areas correspond to the light-transmitting area TA. Note that in FIG. 2, the dotted areas may be referred to as a first light-shielding area LSA1 and the other areas may be referred to as a first light-transmitting area TA1. Note that in FIG. 3, the dotted areas may be referred to as a second light-shielding area LSA2 and the other areas may be referred to as a second light-transmitting area TA2. As described above, the incident light control area PCA is formed when the liquid crystal panel PNL is in a scattered state. That is, the light-shielding area LSA included in the incident light control area PCA is formed by applying a voltage to an electrode disposed at a position overlapping the light-shielding area LSA and driving the liquid crystal layer.

Note that the pattern of the incident light control area PCA formed on the liquid crystal panel PNL is not limited to those shown in FIGS. 2 and 3, and any pattern can be applied thereto.

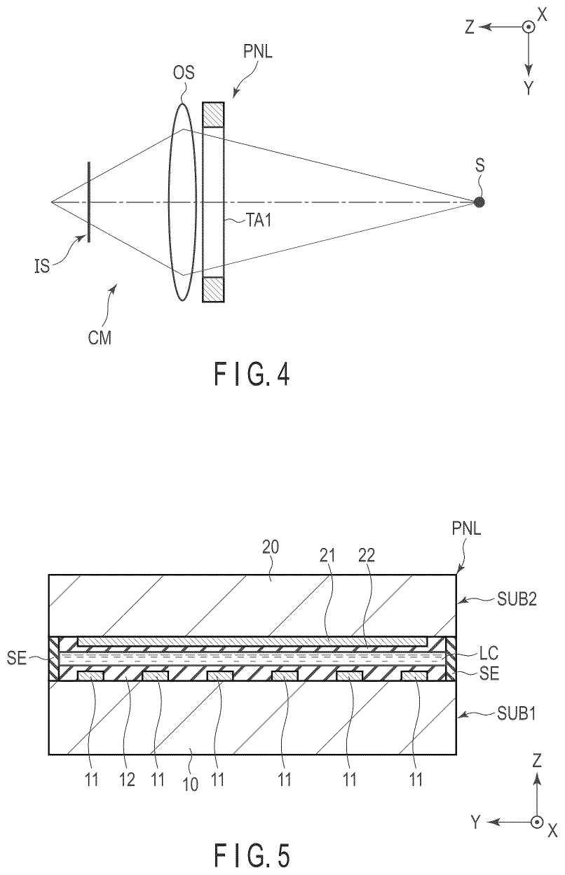

Referring now to FIG. 4, the principle of calculating a distance to the subject using the image picked up by the foregoing camera module CM will be briefly described. FIG. 4 shows the positional relationship between the camera module CM and the subject S. As has been described above, the camera module CM includes a liquid crystal panel PNL, an image sensor IS, and an optical system OS located between the liquid crystal panel PNL and the image sensor IS.

Assume here that a distance to the subject S shown in FIG. 4 is calculated. Generally, in a camera, an image of the subject S can be picked up while the subject S is focused by changing a distance between the optical system OS and the image sensor IS. If, however, an image of the subject S is picked up while the subject S is not focused as shown in FIG. 4, the focal position and the position of the imaging surface of the image sensor IS are shifted from each other, with the result that a blur is caused in the image based on the light incident upon the image sensor IS.

With the foregoing coded-aperture technology, a distance to the subject S is calculated based on the blur caused in the image.

Although FIG. 4 shows the first light-transmitting area TA1 that transmits light, for example, two light-transmitting areas (first and second light-transmitting areas TA1 and TA2) can be prepared as described above to calculate a distance to the subject using a plurality of images based on light transmitted through each of the two light-transmitting areas (that is, a plurality of defocused patterns based on light transmitted through different light-transmitting areas), thus improving the distance-calculation accuracy (distance-measuring accuracy) of the distance.

Next is a description of a configuration example of the liquid crystal panel PNL. FIG. 5 is a schematic sectional view of the liquid crystal panel PNL shown in FIG. 1.

The liquid crystal panel PNL includes a first substrate SUB1, a second substrate SUB2, a liquid crystal layer LC and a seal SE. The first and second substrates SUB1 and SUB2 are opposed to each other. The liquid crystal layer LC is located between the first and second substrates SUB1 and SUB2. The first and second substrates SUB1 and SUB2 are bonded together by the seal SE to seal the liquid crystal layer LC. Note that the liquid crystal panel PNL is not provided with a color filter or a light source because it is only necessary to display a coded-aperture pattern and not to display a visible image.

The first substrate SUB1 includes a transparent substrate 10, a pixel electrode 11 (first electrode) and an alignment film 12 (first alignment film). The second substrate SUB2 includes a transparent substrate 20, a common electrode 21 (second electrode) and an alignment film 22 (second alignment film). The pixel electrode 11 and the common electrode 21 are opposed to each other. The alignment film 12 covers the pixel electrode 11 and is in contact with the liquid crystal layer LC. The alignment film 22 covers the common electrode 21 and is in contact with the liquid crystal layer LC. The pixel electrode 11 and the common electrode 21 are formed of a transparent conductive material such as indium tin oxide (ITO) and indium zinc oxide (IZO). The alignment films 12 and 22 are formed of a polyimide film, for example.

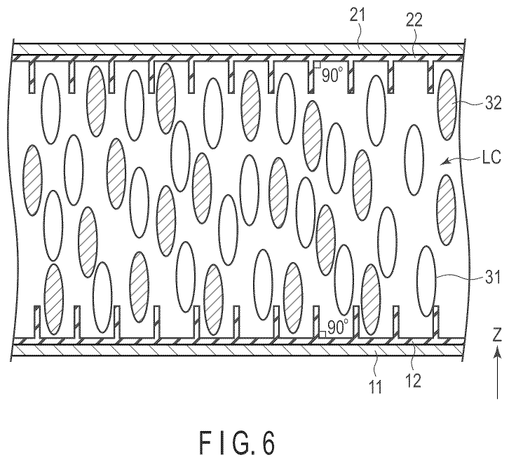

FIG. 6 is a sectional view illustrating a configuration example of the liquid crystal layer LC. As shown in FIG. 6, the liquid crystal layer LC contains liquid crystal molecules 31 and polymers 32. The alignment films 12 and 22 are vertically aligned films having a pretilt angle of 90 degrees (that is, vertically aligned films having anchoring strength along the third direction Z), and the liquid crystal molecules 31 and polymers 32 are aligned according to the pretilt angle.

Each of the liquid crystal molecules 31 and polymers 32 has refractive index anisotropy or optical anisotropy. The liquid crystal molecules 31 are negative ones having negative dielectric constant anisotropy because it is assumed here that the liquid crystal panel PNL is adapted to the reverse mode as described above. The liquid crystal molecules 31 and polymers 32 are different in responsiveness to electric fields. More specifically, the responsiveness of the polymers 32 to the electric fields is lower than that of the liquid crystal molecules 31 to the electric field. Therefore, the alignment direction of the polymers 32 hardly changes regardless of the electric field between the pixel electrode 11 and the common electrode 21, the details of which will be described later. On the other hand, the alignment direction of the liquid crystal molecules 31 changes in response to the electric fields.

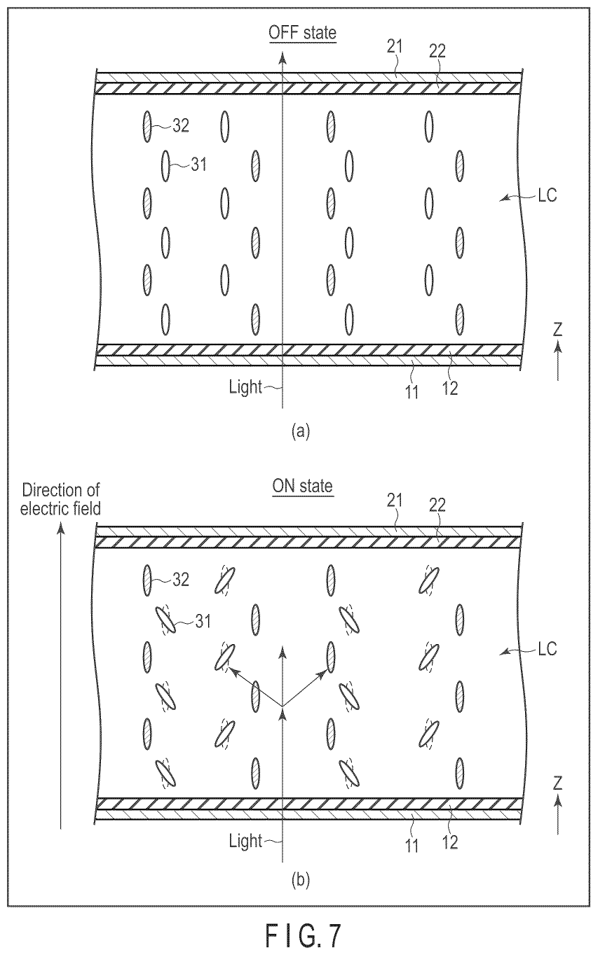

FIG. 7 is a schematic diagrams showing the liquid crystal layer LC shown in FIG. 6 in an OFF state and that in an ON state. FIG. 7(a) is a schematic diagram of the liquid crystal layer LC in the OFF state. The OFF state corresponds to a state in which no voltage is applied to the liquid crystal layer LC (for example, a state in which the potential difference between the pixel electrode 11 and the common electrode 21 is almost 0).

The major axes of the liquid crystal molecules 31 and those of the polymers 32 are parallel to each other. Assume here that the liquid crystal molecules 31 and the polymers 32 are aligned by the alignment films 12 and 22 having anchoring strength that is substantially parallel to the third direction Z as described above. Thus, the major axes of the liquid crystal molecules 31 and those of the polymers 32 are parallel to the third direction Z.

The liquid crystal molecules 31 and the polymers 32 have almost the same refractive index anisotropy. That is, the ordinary photorefractive indices of the liquid crystal molecules 31 and polymers 32 are almost equal to each other, and the extraordinary photorefractive indices of the liquid crystal molecules 31 and polymers 32 are almost equal to each other. Therefore, there is almost no refractive index difference between the liquid crystal molecules 31 and the polymers 32 in all directions including the first, second and third directions X, Y and Z. Accordingly, the light incident upon the liquid crystal layer LC passes through the liquid crystal layer LC.

FIG. 7(b) is a schematic diagram of the liquid crystal layer LC in the ON state. The ON state corresponds to a state in which a voltage is applied to the liquid crystal layer LC (for example, a state in which the potential difference between the pixel electrode 11 and the common electrode 21 is equal to or greater than a threshold value). As described above, the responsiveness of the polymers 32 to the electric field is lower than that of the liquid crystal molecules 31 to the electric field, and the alignment direction of the polymers 32 hardly changes regardless of the presence or absence of the electric field. On the other hand, the alignment direction of the liquid crystal molecules 31 changes with the electric field while a voltage that is higher than a threshold value is applied to the liquid crystal layer LC. That is, as shown in FIG. 7(b), while the major axes of the polymers 32 are almost parallel to the third direction z, the major axes of the liquid crystal molecules 31 are inclined with respect to the third direction Z. As described above, the liquid crystal molecules 31 are negative ones and thus aligned along a direction in which their major axes intersect with the electric field. That is, the major axes of the liquid crystal molecules 31 and those of the polymers 32 intersect with each other. Thus, a large difference in refractive index is caused between the liquid crystal molecules 31 and the polymers 32 in all directions including the first, second and third directions X, Y and Z. Accordingly, the light incident upon the liquid crystal layer LC is scattered isotropically in the liquid crystal layer LC, and an incident light control area PCA is formed in the liquid crystal panel PNL (a coded-aperture pattern is displayed).

As described above, the camera module CM according to the present embodiment includes a liquid crystal panel PNL having a liquid crystal layer LC of a polymer dispersed liquid crystal, an optical system OS and an image sensor IS. In the liquid crystal panel PNL, and a large number of incident light control areas PCA are formed when the liquid crystal layer LC is in an ON state. Thus, the camera module CM can function as a distance-measuring sensor that calculates a distance from an image based on light incident upon the image sensor IS to a subject when the liquid crystal layer LC is in an ON state and it can function as a camera that picks up an image based on light incident upon the image sensor IS when the liquid crystal layer LC is in an OFF state.

The liquid crystal layer LC of polymer dispersed liquid crystal requires no polarizer and thus has a feature that its transmittance is higher than other liquid crystal layers that require a polarizer. If, therefore, the camera module CM is caused to function as a camera, a larger amount of light can be made incident upon the image sensor IS and a higher-quality image can be picked up than when another camera module using a liquid crystal panel having another liquid crystal layer is caused to function as a camera, and a high-quality image can be photographed.

In addition, the camera module CM according to the present embodiment is provided with a liquid crystal panel PNL including alignment films 12 and 22 (vertical alignment films) having anchoring strength along the third direction Z and a liquid crystal layer LC including negative liquid crystal molecules 31 and polymers 32 aligned along the third direction Z by the vertical alignment films. In general, if a liquid crystal panel includes an alignment film having anchoring strength along the horizontal direction (horizontal alignment film) and a liquid crystal layer including positive liquid crystal molecules and polymers aligned along the horizontal direction by the horizontal alignment film, light incident upon the ON-state liquid crystal layer is not scattered isotropically within the liquid crystal layer but is scattered in a predetermined direction. If such a liquid crystal panel is used in a camera module, the camera module is unlikely to function as a distance-measuring sensor that calculates (measures) the distance to a subject with accuracy. Since, however, the camera module CM according to the present embodiment is provided with a liquid crystal panel PNL including a vertical alignment film as described above, light incident upon the liquid crystal layer LC can be scattered isotropically in the liquid crystal layer LC, and the distance to a subject can be calculated (measured) with accuracy.

### (First Modification)

In the present embodiment described above, the liquid crystal layer LC includes liquid crystal molecules 31 and polymers 32 aligned along the third direction Z, but the liquid crystal layer LC may include liquid crystal molecules 31 and polymers 32 in twist alignment.

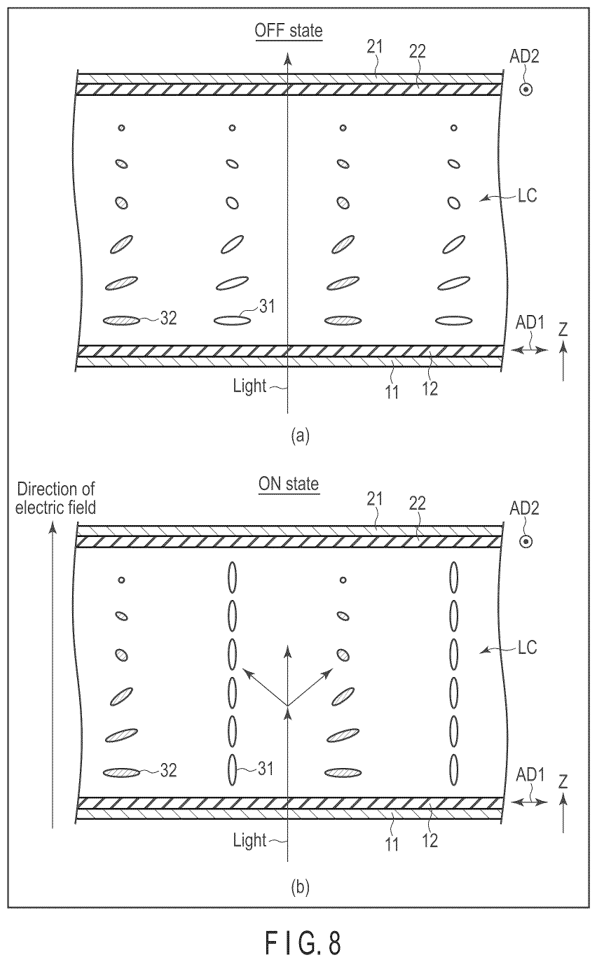

FIG. 8 is a schematic diagrams showing an OFF-state liquid crystal layer LC and ON-state liquid crystal layer LC both including liquid crystal molecules 31 and polymers 32 in twist alignment. The alignment treatment direction AD1 of the alignment film 12 and the alignment treatment direction AD2 of the alignment film 22 are different from each other. It is assumed in FIG. 8 that the alignment treatment directions AD1 and AD2 are orthogonal to each other. Note that the alignment treatment may be rubbing treatment or optical alignment treatment.

In the liquid crystal layer LC, a chiral agent is added to the liquid crystal molecules 31 and polymers 32, and the liquid crystal molecules 31 and polymer 32 are twist-aligned. It is assumed in FIG. 8 that the liquid crystal molecules 31 and polymers 32 are twist-aligned 90° between the alignment films 12 and 22. The liquid crystal molecules 31 are positive ones having positive dielectric constant anisotropy.

FIG. 8(a) is a schematic diagram showing an Off-state liquid crystal layer LC. As shown in FIG. 8(a), the liquid crystal molecules 31 and the polymers 32 are aligned in the longitudinal direction in the liquid crystal layer LC. The liquid crystal molecules 31 and the polymers 32 have almost the same refractive index anisotropy. That is, the ordinary refractive indices of the liquid crystal molecules 31 and the polymers 32 are almost equal to each other, as are the extraordinary refractive indices thereof. Therefore, there is almost no refractive index difference between the liquid crystal molecules 31 and the polymers 32 in all directions including the first, second and third directions X, Y and Z. Accordingly, the light incident upon the liquid crystal layer LC passes through the liquid crystal layer LC.

FIG. 8(b) is a schematic diagram showing an ON-state liquid crystal layer LC. As described above, the responsiveness of the polymers 32 to the electric field is lower than that of the liquid crystal molecules 31 to the electric field, and the alignment direction of the polymers 32 hardly changes regardless of the presence or absence of the electric field. On the other hand, the alignment direction of the liquid crystal molecules 31 changes with the electric field while a voltage that is higher than a threshold value is applied to the liquid crystal layer LC. That is, as shown in FIG. 8(b), the major axes of the polymers 32 hardly change from the OFF state shown in FIG. 8(a), while the major axes of the liquid crystal molecules 31 are parallel to the third direction Z. It is assumed here that the liquid crystal molecules 31 are positive ones as described above and thus their major axes are aligned along the electric field and are parallel to the third direction Z. Thus, the major axes of the liquid crystal molecules 31 and polymers 32 intersect with each other. Therefore, there is a large refractive index difference between the liquid crystal molecules 31 and the polymers 32 in all directions including the first, second and third directions X, Y and Z. Accordingly, the light incident upon the liquid crystal layer LC is scattered isotropically in the liquid crystal layer LC, and an incident light control area PCA is formed on the liquid crystal panel PNL (a coded-aperture pattern is displayed).

Even in the case where the liquid crystal layer LC includes the twist-aligned liquid crystal molecules 31 and polymers 32 as described above, no polarizer is required as in the case shown in FIG. 7. It is thus possible to pick up a high-quality image when the camera module CM functions as a camera. In addition, when the liquid crystal layer LC includes twist-aligned liquid crystal molecules 31 and polymers 32, the scattered light can be made isotropic even though the alignment films 12 and 22 are horizontally aligned films. Thus, the distance to a subject can be calculated with accuracy when the camera module CM is caused to function as a distance-measuring sensor.

### (Second Modification)

In the present embodiment described above, the liquid crystal layer LC includes liquid crystal molecules 31 and polymers 32 aligned along the third direction Z, but the liquid crystal layer LC may further include dichroic dye molecules 33.

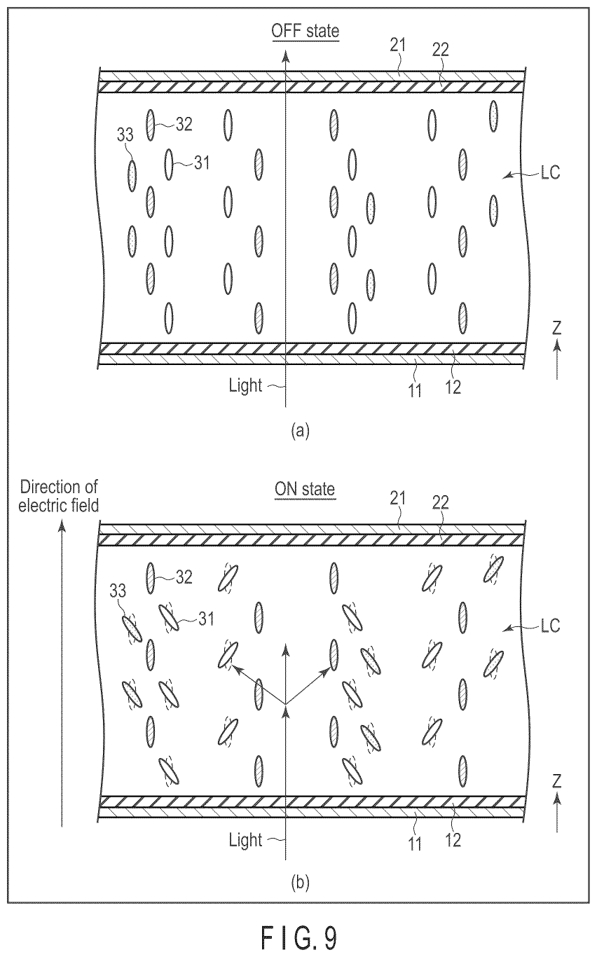

FIG. 9 is a schematic diagrams showing an OFF-state liquid crystal layer LC and an ON-state liquid crystal layer LC which are shown in FIG. 7 and to which a dichroic dye (guest) is added. As shown in FIG. 9(a), the dichroic dye molecules 33 are aligned with the liquid crystal molecules 31. That is, the major axes of the liquid crystal molecules 31 and those of the dichroic dye molecules 33 are parallel to each other. It is assumed in FIG. 9 that the liquid crystal molecules 31 and the polymers 32 are aligned by the alignment films 12 and 22 having anchoring strength substantially parallel to the third direction Z as in the case shown in FIG. 7. Thus, the major axes of the liquid crystal molecules 31, those of the polymers 32 and those of the dichroic dye molecules 33 are parallel to the third direction Z.

The liquid crystal molecules 31 and the polymers 32 have almost the same refractive index anisotropy. That is, the ordinary refractive indices of the liquid crystal molecules 31 and the polymers 32 are almost equal to each other, as are the extraordinary refractive indices thereof. Therefore, there is almost no refractive index difference between the liquid crystal molecules 31 and the polymers 32 in all directions including the first, second and third directions X, Y and Z.

In addition, the dichroic dye molecules 33 have different absorbances in the major and minor axis directions. More specifically, the dichroic dye molecules 33 absorb light that oscillates in the major axis direction and transmit light that oscillates in the minor axis direction. As described above, the dichroic dye molecules 33 are aligned following the liquid crystal molecules 31, and in the OFF state, their major axes are parallel to the third direction Z, and they transmit light that oscillates in the minor axis direction.

As described above, in the OFF state, there is almost no refractive index difference between the liquid crystal molecules 31 and the polymers 32 in all directions, and the dichroic dye molecules 33 transmit light that oscillates in the minor axis direction. Thus, light incident upon the liquid crystal layer LC passes through the liquid crystal layer LC.

FIG. 9(b) is a schematic diagram showing an ON-state liquid crystal layer LC. As described above, the responsiveness of the polymers 32 to the electric field is lower than that of the liquid crystal molecules 31 to the electric field, and the alignment direction of the polymers 32 hardly changes regardless of the presence or absence of the electric field. On the other hand, the alignment direction of the liquid crystal molecules 31 changes with the electric field while a voltage that is higher than a threshold value is applied to the liquid crystal layer LC. That is, as shown in FIG. 9(b), the major axes of the polymers 32 are almost parallel to the third direction Z, while the major axes of the liquid crystal molecules 31 are inclined with respect to the third direction Z. Since the liquid crystal molecules 31 are negative ones as in the case of FIG. 7, they are aligned along a direction in which their major axes intersect with the electric field. That is, the major axes of the liquid crystal molecules 31 and those of the polymers 32 intersect with each other. Thus, a large refractive index difference occurs between the liquid crystal molecules 31 and the polymers 32 in all directions including the first, second and third directions X, Y and Z.

In addition, as described above, the dichroic dye molecules 33 are aligned following the liquid crystal molecules 31, and in the ON state, they are aligned along a direction in which their major axes intersect with the electric field to absorb light that oscillates in the major axis direction.

As described above, in the ON state, a large refractive index difference occurs between the liquid crystal molecules 31 and the polymers 32 in all directions, and the dichroic dye molecules 33 absorb light that oscillates in the major axis direction. Thus, the light incident upon the liquid crystal layer LC is scattered isotropically in the liquid crystal layer LC, and an incident light control area PCA is formed on the liquid crystal panel PNL (a coded-aperture pattern is formed).

Even in the case where the liquid crystal layer LC further includes the dichroic dye molecules 33 as described above, no polarizer is required as in the case shown in FIG. 7. It is thus possible to pick up a high-quality image when the camera module CM is caused to function as a camera. Since, in this case, a liquid crystal panel PNL including vertically aligned films as in the case shown in FIG. 7, the light incident upon the liquid crystal layer LC can be scattered isotropically in the liquid crystal layer LC, and the distance to a subject can be calculated with accuracy.

In addition, since the liquid crystal layer LC includes the dichroic dye molecules 33, they absorb light that oscillates in the major axis direction in the ON state, with the result that the display surface of the liquid crystal panel PNL can be colored and thus the contrast of the liquid crystal panel PNL can be improved.

The embodiment described above can provide a camera module CM including a liquid crystal panel PNL whose transmittance is high.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A camera module comprising:
a liquid crystal panel which displays a coded-aperture pattern;
an image sensor; and
an optical system located between the liquid crystal panel and the image sensor,
wherein the liquid crystal panel includes a liquid crystal layer containing liquid crystal molecules and polymers.

2. The camera module of claim 1, wherein:
the liquid crystal panel includes a first substrate including a first electrode, a second substrate opposed to the first substrate and including a second electrode, and the liquid crystal layer located between the first substrate and the second substrate; and
the liquid crystal panel is brought into a transparent state when no electric field is applied to the liquid crystal layer and is brought into a scattered state when an electric field is applied to the liquid crystal layer.

3. The camera module of claim 2, wherein:
the first substrate includes a first alignment film which covers the first electrode and which is in contact with the liquid crystal layer;
the second substrate includes a second alignment film which covers the second electrode and which is in contact with the liquid crystal layer; and
the first alignment film and the second alignment film are vertically aligned films.

4. The camera module of claim 3, wherein the liquid crystal layer further includes dichroic dye molecules aligned following the liquid crystal molecules.

5. The camera module of claim 2, wherein:
the first substrate includes a first alignment film which covers the first electrode and which is in contact with the liquid crystal layer;
the second substrate includes a second alignment film which covers the second electrode and which is in contact with the liquid crystal layer;
the first alignment film and the second alignment film are horizontally aligned films whose alignment treatment directions are different from each other; and
the liquid crystal layer includes twist-aligned liquid crystal molecules and polymers.
